(19) United States
(12) Patent Application Publication
(10) Pub. No.: US 2011/0135170 A1
(43) Pub. Date: Jun. 9, 2011

(54) SYSTEM AND METHOD FOR DISPLAY SPEED CONTROL OF CAPSULE IMAGES

(75) Inventor: Kang-Huai Wang, Saratoga, CA (US)

(73) Assignee: CAPSO VISION, INC., Saratoga, CA (US)

(21) Appl. No.: 12/634,009

(22) Filed: Dec. 9, 2009

(51) Int. Cl. G06K 9/00

(52) U.S. Cl. 382/128

(57) ABSTRACT

Systems and methods are provided for display speed control of images captured from a capsule camera system. For capsule systems, with either digital wireless transmission or on-board storage, the captured images will be played back for analysis and examination. During playback, the diagnostician wishes to find polyps or other points of interest as quickly and efficiently as possible. The present invention discloses systems and methods for display speed based on image complexity. A higher visual complexity will result in longer display time so that the diagnostician can examine the underlying images longer. Conversely, a lower visual complexity will result in shorter display time. The visual complexity may be derived from image contours/edges or spatial frequencies.

### FIELD OF THE INVENTION

The present invention relates to diagnostic imaging inside the human body. In particular, the present invention relates to displaying images captured by a capsule camera system.

### BACKGROUND

Devices for imaging body cavities or passages in vivo are known in the art and include endoscopes and autonomous encapsulated cameras. Endoscopes are flexible or rigid tubes that pass into the body through an orifice or surgical opening, typically into the esophagus via the mouth or into the colon via the rectum. An image is formed at the distal end using a lens and transmitted to the proximal end, outside the body, either by a lens-relay system or by a coherent fiber-optic bundle. A conceptually similar instrument might record an image electronically at the distal end, for example using a CCD or CMOS array, and transfer the image data as an electrical signal to the proximal end through a cable. Endoscopes allow a physician control over the field of view and are well-accepted diagnostic tools. However, they do have a number of limitations, present risks to the patient, are invasive and uncomfortable for the patient, and their cost restricts their application as routine health-screening tools.

Because of the difficulty traversing a convoluted passage, endoscopes cannot reach the majority of the small intestine and special techniques and precautions, that add cost, are required to reach the entirety of the colon. Endoscopic risks include the possible perforation of the bodily organs traversed and complications arising from anesthesia. Moreover, a trade-off must be made between patient pain during the procedure and the health risks and post-procedural down time associated with anesthesia. Endoscopies are necessarily inpatient services that involve a significant amount of time from clinicians and thus are costly.

An alternative in vivo image sensor that addresses many of these problems is capsule endoscope. A camera is housed in a swallowable capsule, along with a radio transmitter for transmitting data, primarily comprising images recorded by the digital camera, to a base-station receiver or transceiver and data recorder outside the body. The capsule may also include a radio receiver for receiving instructions or other data from a base-station transmitter. Instead of radio-frequency transmission, lower-frequency electromagnetic signals may be used. Power may be supplied inductively from an external inductor to an internal inductor within the capsule or from a battery within the capsule.

An autonomous capsule camera system with on-board data storage was disclosed in the U.S. patent application Ser. No. 11/533,304, entitled “In Vivo Autonomous Camera with On-Board Data Storage or Digital Wireless Transmission in Regulatory Approved Band,” filed on Sep. 19, 2006. This application describes a capsule system using on-board storage such as semiconductor nonvolatile archival memory to store captured images. After the capsule passes from the body, it is retrieved. Capsule housing is opened and the images stored are transferred to a computer workstation for storage and analysis.

The above mentioned capsule cameras use forward looking view where the camera looks toward the longitude direction from one end of the capsule camera. It is well known that there are sacculations that are difficult to see from a capsule that only sees in a forward looking orientation. For example, ridges exist on the walls of the small and large intestine and also other organs. These ridges extend somewhat perpendicular to the walls of the organ and are difficult to see behind. A side or reverse angle is required in order to view the tissue surface properly. Conventional devices are not able to see such surfaces, since their FOV is substantially forward looking. It is important for a physician to see all areas of these organs, as polyps or other irregularities need to be thoroughly observed for an accurate diagnosis. Since conventional capsules are unable to see the hidden areas around the ridges, irregularities may be missed, and critical diagnoses of serious medical conditions may be flawed.

A camera configured to capture a panoramic image of an environment surrounding the camera is disclosed in U.S. patent application Ser. No. 11/642,275, entitled “In vivo sensor with panoramic camera” and filed on Dec. 19, 2006. The panoramic camera is configured with a longitudinal field of view (FOV) defined by a range of view angles relative to a longitudinal axis of the capsule and a latitudinal field of view defined by a panoramic range of azimuth angles about the longitudinal axis such that the camera can capture a panoramic image covering substantially a 360 deg latitudinal FOV.

For capsule systems, with either digital wireless transmission or on-board storage, the captured images will be played back for analysis and examination. During playback, the diagnostician wishes to find polyps or other points of interest as quickly and efficiently as possible. The playback can be at a controllable frame rate and may be increased to reduce viewing time. A main purpose for the diagnostician to view the video is to identify polyps or other points of interest. In other words, the diagnostician is performing a visual cognitive task on the images. A plain image with very few objects or features, the human eyes can quickly perceive and recognize the contents. For an image with more objects or complex scenes, it will take more time for the eyes to perceive and recognize the contents. Therefore, it is desirable to have a video display system which will display the underlying video at a higher speed when the contents are of low complexity and at a lower speed when the contents are of high complexity. This will allow the diagnostician to spend more time on higher complexity images and less time on lower complexity images. Consequently, the diagnostician may complete the examination quicker or achieve more reliable diagnosis using the same amount of viewing time.

### SUMMARY

The present invention provides methods and systems for displaying an image sequence generated from a capsule camera system at a display speed based on the complexity of the image. In one embodiment of the present invention, a method for processing video of images captured by a capsule camera system is disclosed which comprises receiving images captured by a capsule camera system, determining image characteristics, wherein the image characteristics include image spatial complexity; and tagging the image with a temporal factor based on the determined image characteristics. In another embodiment, the method further generates a target video data based on the associated temporal factors and a global temporal factor, wherein each of the received images is omitted in the target video data, or outputted to the target video data once or a plurality of times according to the temporal factor associated with the image and the global temporal factor. In yet another embodiment, the method further stores the received images and associated temporal factors in separate files. In an alternative embodiment, the received images are displayed on a display based on the associated temporal factors and a global temporal factor, wherein each of the received images is skipped, or displayed on the display once or a plurality of times according to the temporal factor associated with the image and the global temporal factor. The image characteristics may further include temporal complexity of underlying images.

In another embodiment of the present invention, a system for displaying video of images captured by a capsule camera system is disclosed which comprises an input interface module coupled to receive images captured by a capsule camera system; a processing module configured to determine image characteristics of the received image, wherein the image characteristics include image spatial complexity; and an output processing module configured to generate outputs comprising the received image and a temporal factor based on the determined image characteristics. In yet another embodiment of the present invention, the system further comprises an output interface module coupled to the output processing module, wherein the output interface module controls the received images being outputted to a target video data based on the associated temporal factors and a global temporal factor, wherein each of the received images is omitted in the target video data, or outputted to the target video data once or a plurality of times according to the temporal factor associated with the image and the global temporal factor. In another embodiment of the present invention, the system further comprises a display interface module coupled to the output processing module, wherein the display interface module controls the received images being displayed on a display based on the associated temporal factors and a global temporal factor, wherein each of the received images is skipped, or displayed on the display once or a plurality of times according to the temporal factor associated with the image and the global temporal factor. The image characteristics may further include temporal complexity of underlying images.

### BRIEF DESCRIPTION OF THE DRAWINGS

FIG. 1 shows schematically a capsule camera system in the GI tract, where archival memory is used to store capsule images to be analyzed and/or examined.

FIG. 2 shows schematically a capsule camera system in the GI tract, where wireless transmission is used to send capsule images to a base station for further analysis and/or examination.

FIG. 3 shows an exemplary zigzag scan for 8×8 DCT coefficients.

FIG. 4A shows an exemplary scene of a capsule image having multiple objects.

FIG. 4B shows exemplary edges of objects corresponding to FIG. 4A.

FIG. 5 shows a system block diagram corresponding to one embodiment incorporating the present invention.

FIG. 6 shows a system block diagram corresponding to another embodiment where a target video data file is generated with display speed adapted to the visual complexity.

FIG. 7 shows a system block diagram corresponding to another embodiment where received images are displayed on a display device with display speed adapted to the visual complexity.

FIGS. 8A-B show a system block diagram corresponding to another embodiment where a data file comprising the received images and temporal factors is generated and the data file is used for display.

FIGS. 9A-C show examples of conventional display system where video display speed is adjusted according to the global temporal factor.

FIGS. 10A-C show examples of one embodiment of the present invention where video display speed is adjusted based on the temporal factor and global temporal factor.

FIG. 11 shows a flowchart of processing steps corresponding to a system embodying the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

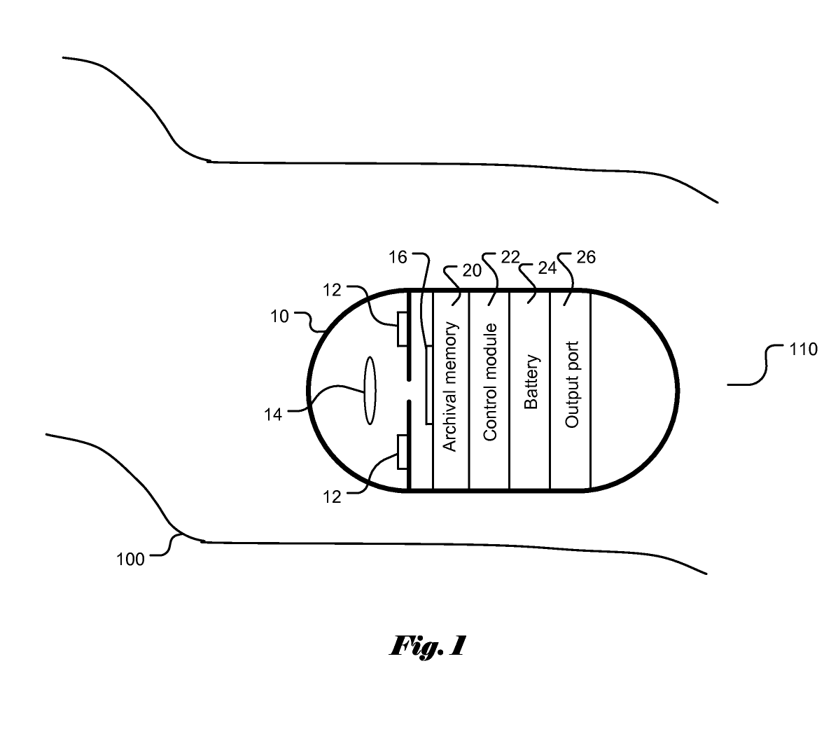

The present invention discloses methods and systems for display speed control of images captured by a capsule camera system. The images may be received from a capsule camera system having on-board archival memory to store the images or received from a capsule camera having wireless transmission module. FIG. 1 shows a swallowable capsule system 110 inside body lumen 100, in accordance with one embodiment of the present invention. Lumen 100 may be, for example, the colon, small intestines, the esophagus, or the stomach. Capsule system 110 is entirely autonomous while inside the body, with all of its elements encapsulated in a capsule housing 10 that provides a moisture barrier, protecting the internal components from bodily fluids. Capsule housing 10 is transparent or partially, so as to allow light from the light-emitting diodes (LEDs) of illuminating system 12 to pass through the wall of capsule housing 10 to the lumen 100 walls, and to allow the scattered light from the lumen 100 walls to be collected and imaged within the capsule. Capsule housing 10 also protects lumen 100 from direct contact with the foreign material inside capsule housing 10. Capsule housing 10 is provided a shape that enables it to be swallowed easily and later to pass through of the GI tract. Generally, capsule housing 10 is sterile, made of non-toxic material, and is sufficiently smooth to minimize the chance of lodging within the lumen.

As shown in FIG. 1, capsule system 110 includes illuminating system 12 and a camera that includes optical system 14 and image sensor 16. A semiconductor nonvolatile archival memory 20 may be provided to allow the images to be retrieved at a docking station outside the body, after the capsule is recovered. System 110 includes battery power supply 24 and an output port 26. Capsule system 110 may be propelled through the GI tract by peristalsis.

Illuminating system 12 may be implemented by LEDs. In FIG. 1, the LEDs are located adjacent the camera's aperture, although other configurations are possible. The light source may also be provided, for example, behind the aperture. Other light sources, such as laser diodes, may also be used. Alternatively, white light sources or a combination of two or more narrow-wavelength-band sources may also be used. White LEDs are available that may include a blue LED or a violet LED, along with phosphorescent materials that are excited by the LED light to emit light at longer wavelengths. The portion of capsule housing 10 that allows light to pass through may be made from bio-compatible glass or polymer.

Optical system 14, which may include multiple refractive, diffractive, or reflective lens elements, provides an image of the lumen walls on image sensor 16. Image sensor 16 may be provided by charged-coupled devices (CCD) or complementary metal-oxide-semiconductor (CMOS) type devices that convert the received light intensities into corresponding electrical signals. Image sensor 16 may have a monochromatic response or include a color filter array such that a color image may be captured (e.g. using the RGB or CYM representations). The analog signals from image sensor 16 are preferably converted into digital form to allow processing in digital form. Such conversion may be accomplished using an analog-to-digital (A/D) converter, which may be provided inside the sensor (as in the current case), or in another portion inside capsule housing 10. The A/D unit may be provided between image sensor 16 and the rest of the system. LEDs in illuminating system 12 are synchronized with the operations of image sensor 16. One function of control module 22 is to control the LEDs during image capture operation.

After the capsule camera traveled through the GI tract and exits from the body, the capsule camera is retrieved and the images stored in the archival memory are read out through the output port. The received images are usually transferred to a base station for processing and for a diagnostician to examine. The accuracy as well as efficiency of diagnostics is most important. A diagnostician is expected to examine all images and correctly identify all anomalies. In order to help the diagnostician to perform the examination more efficiently without compromising the quality of examination, the received images are subject to processing of the present invention by slowing down where the eyes may need more time to identify anomalies and speeding up where the eyes can quickly identify the anomalies.

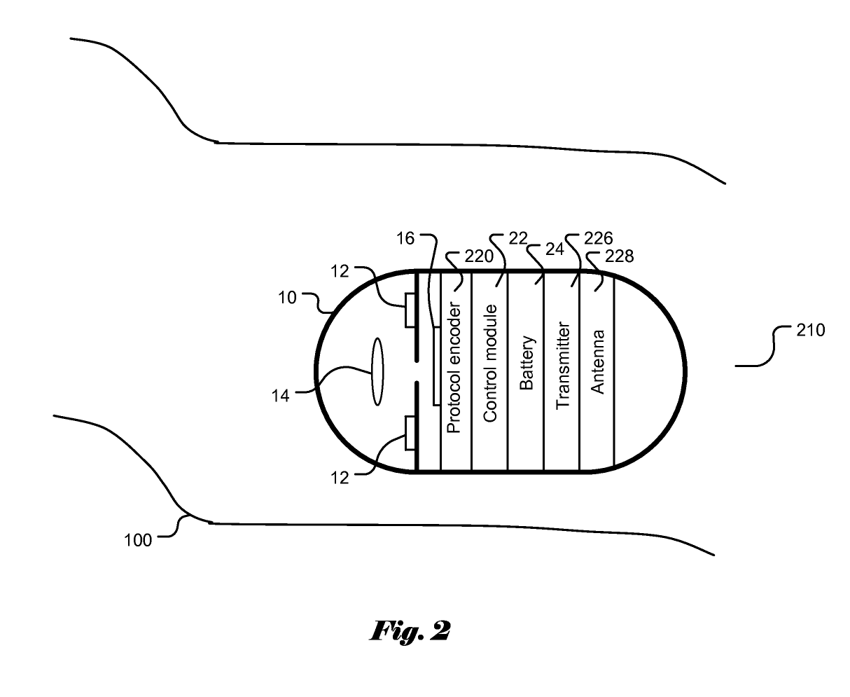

FIG. 2 shows an alternative swallowable capsule system 210. Capsule system 210 may be constructed substantially the same as capsule system 110 of FIG. 1, except that archival memory system 20 and output port 26 are no longer required. Capsule system 210 also includes communication protocol encoder 220, transmitter 226 and antenna 228 that are used in the wireless transmission to transmit captured images to a receiving device attached or carried by the person being administered with a capsule system 210. The elements of capsule 110 and capsule 210 that are substantially the same are therefore provided the same reference numerals. Their constructions and functions are therefore not described here repeatedly. Communication protocol encoder 220 may be implemented in software that runs on a DSP or a CPU, in hardware, or a combination of software and hardware. Transmitter 226 and antenna system 228 are used for transmitting the captured digital image.

While the capsule camera systems shown in FIG. 1 and FIG. 2 illustrate a forward looking system, the present invention is not limited to video captured by the forward looking capsule camera system and can also be applied to other types of capsule camera system such as panoramic camera systems as disclosed in U.S. patent application Ser. No. 11/642,275, entitled “In vivo sensor with panoramic camera” and filed on Dec. 19, 2006.

For capsule systems, with either digital wireless transmission or on-board storage, the captured images will be played back for analysis and examination. During playback, the diagnostician wishes to find polyps or other points of interest as quickly and efficiently as possible. The playback may be at a controllable frame rate and may be increased to reduce viewing time. Since a main purpose of for the diagnostician to view the video is to identify find polyps or other points of interest, the diagnostician will perform the visual cognitive task. For both traditionally colonoscopy and capsule colon endoscopy the fatigue factors become a major problem in efficacy. With the rampant colon cancer rate, all population above 40-50 years old are recommended for regular colon examination but there are only limited doctors. For traditional colonoscopy the detection rate drops after 3-5 procedures because the procedure requires about 30 minutes of highly technical maneuver of colonoscope. For capsule colon endoscope each reading of 10's or 100's thousands of images per patient could easily make doctors get fatigue and lower the detection rate. The vast majority public do not comply the recommendation for regular colon check up due to the invasiveness of the procedure. The capsule colon endoscope is supposed to increase the compliance rate tremendously, so the issue of reducing fatigue is critical. The other critical issue is cost. The doctor's time is expensive, is the major component among both colonoscopy procedures and if the viewing throughput could be increased so is the total healthcare cost. Currently the waiting time for a colonoscopy examination appointment is several weeks, more likely several months. With the dramatic increase in compliance rate with the use of capsule endoscope there won't be enough doctors to meet the demand so to reduce the viewing time has another important meaning. One of the goals of the present invention is to provide systems and methods to reduce the cost for doctor's time to view the images without compromising the detection rate.

Intuitively, a plain image with very few objects or features, the human eyes can quick perceive and recognize the contents. For an image with more objects or more complex scenes, it will take more time for the eyes to perceive and recognize the contents. Some scientific studies have been conducted and confirmed the above intuition. For example, in the report entitled “Coding of Visual Object Features and Feature Conjunctions in the Human Brain”, by Martinovic et al., in PLoS ONE. 2008; 3(11): e3781, published online 2008 Nov. 21, (http://www.ncbi.nlm.nih.gov/pmc/articles/PMC2582493/pdf/pone.0003781.pdf), various test images were presented to human subjects and the response time for recognizing the visual contents was measured. The test images are divided into low visual complexity group and high visual complexity group. The studies concluded that significantly higher response times for more complex objects are found in an across item comparison of objects differing in conceptual complexity. Based on the above study, it confirms the intuition that images with higher visual complexity may take more time to recognize. Consequently, it is desirable to adjust the playback speed of the images based on the visual complexity of the image. In the field on video compression, video complexity is often used to control bit rate. For example, in the MPEG-2 literature, spatial activity measured by the variance of luminance signal is used as video complexity. In the U.S. Pat. No. 7,512,181, entitled “single pass variable bit rate control strategy and encoder for processing a video frame of a sequence of video frames”, the spatial complexity (also called video activity) is used for bit rate control, where the spatial complexity is measured by the standard deviation of the luminance of the video. Alternatively, the spatial complexity may be measured by the edge gradients or texture complexity measurements. In one embodiment, the chrominance complexity is also considered.

In the study mentioned above, the visual complexity can be measured either through mean subjective ratings of images' detail, or objectively through the JPEG file size. The JPEG is a standard still image compression technique that uses a discrete cosine transform (DCT) on image blocks consisting of 8×8 pixels, followed by quantization and entropy coding. For an image block with low visual complexity, the corresponding DCT typically contains a few larger values in low-frequency region. After quantization, this low-complexity block can be efficiently coded by the subsequent entropy coding and results in a low-bit rate. Conversely, for a block having high visual complexity, it will result in a high bit rate for the block. Therefore, the file size is a good indication of image visual complexity. For some capsule camera systems, the captured images may be already in the JPEG format and the visual complexity based on the JPEG file size is readily available. Furthermore, the above study also finds that it is more accurate to use objective measures of image complexity based on JPEG file size than the subjective rating based on human subjects.

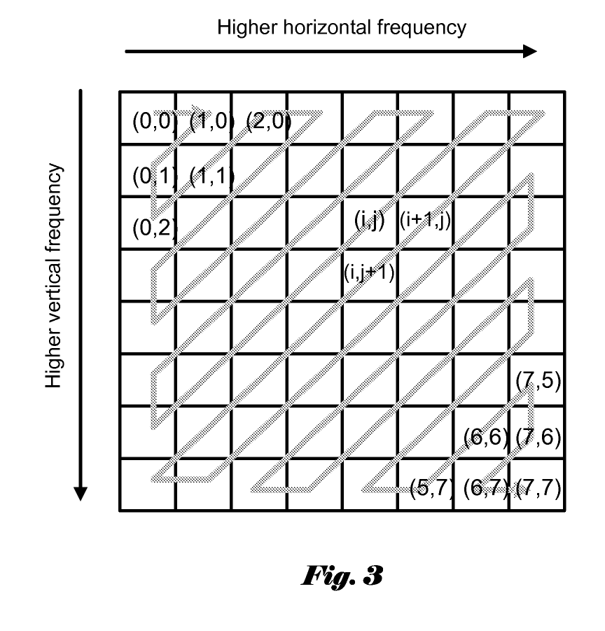

While the JPEG file size is a way to estimate the visual complexity, other DCT-based visual complexity measurement is also possible. The DCT coefficients represent image characteristics in the frequency domain. The visual complexity is usually associated with texture (i.e., surface details) and contours/edges. The very low frequency region of the DCT coefficients may be associated with the smooth or plain part of the block. An extremely high frequency region of the DCT coefficients may be associated with noise. The energy of the DCT coefficients in the mid- to high-frequency regions may be a better estimate of the visual complexity. An 8×8 DCT is popularly used for image compression, particularly in the JPEG standard. The two-dimensional DCT coefficients are converted into a one-dimensional signal in a zigzag pattern from low frequency to high frequency as shown in FIG. 3 for further processing such as quantization and entropy coding. The two-dimensional DCT coefficient may be represented as X(i,j,) where 0≦i,j≦7 and X(0,0) is the DC term and X(7,7) is the term corresponding to the highest two-dimensional frequency. The index (i,j) in FIG. 3 indicates the location of DCT coefficient X(i,j) in the two-dimensional frequency space. The indexes for the DCT coefficients corresponding to the lowest frequencies and the highest frequencies are shown in FIG. 3. After the zigzag scan, the two-dimensional DCT coefficients become one-dimensional coefficients represented as X′(n) where 0≦n≦63. According to FIG. 3, X(0,0) is mapped to X′(0), X(1,0) is mapped to X′(1), X(0,1) is mapped to X′(2), . . . , X(7,6) is mapped to X′(61), X(6,7) is mapped to X′(62), and X(7,7) is mapped to X′(63). The energy in the mid-to high-frequency region for the 8×8 DCT based system can be calculated from the squared sum of one-dimensional DCT coefficients:

$$E = {\sum }_{k = K 1}^{K 2} {{X}^{′}}^{2} ( k ) \qquad ( 1 )$$

where 0≦K1<K2≦63.

There is a spatial activity measure often used in video compression for the purpose of bit rate control. The measure is calculated for each macroblock which consists of 16×16 luminance pixels. For intra-coded picture (the picture is processed without reference to other pictures), the activity Cₖ is measured as the variance of the macroblock:

$${C}_{k} = {\sum }_{( x , y ) ∈ {MB}_{k}} {( f ( x , y ) - {\overline{f}}_{k} )}^{2} \qquad ( 2 )$$

where f(x,y) is the pixel value at (x,y), MBₖ is the k-th macroblock and f̅ₖ is the mean value of the k-th macroblock. For the application in activity-based display control, the activity can be calculated based on any block size. For example, a block consists of 8×8 pixels may also be used. The activity measure for the picture is calculated as the summation of activities of all blocks in the picture.

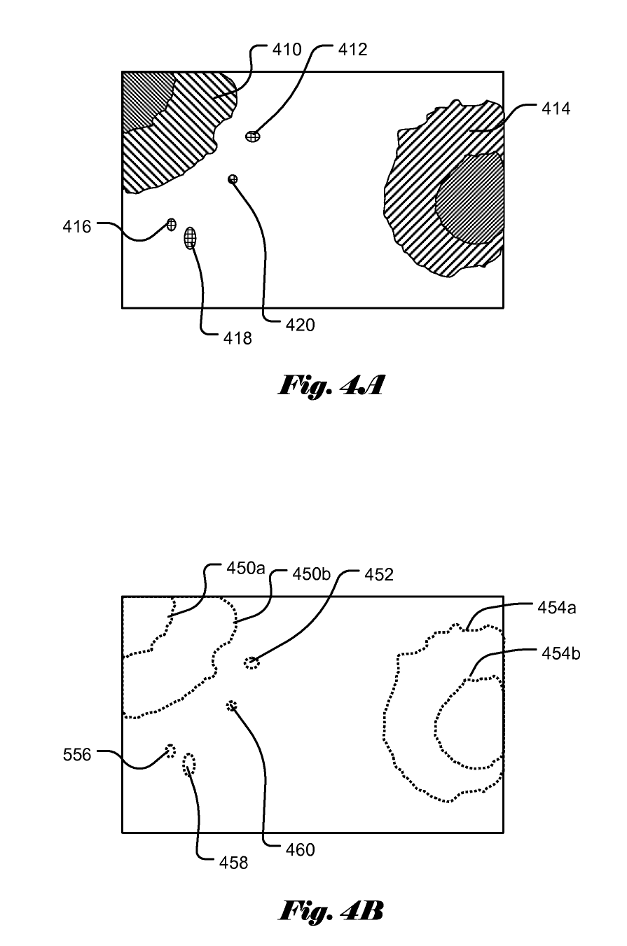

In addition to the DCT based and the block variance based visual complexity measurement, the image contour or image edge is also a good indication of visual complexity. Again, in the study by Martinovic et al, the effect that contours and edges will also delay the time for object recognition is discussed. The terms of edge and contour may be used interchangeably in some contexts. However, often the contour is referring to connected edges corresponding to the boundaries of an object. In this specification, the edge may be referring to a contour or a connected edge. An exemplary illustration of a capsule image containing edges is shown in FIG. 4A where the image contains multiple objects labeled as 410-420. Image processing can be applied to the capsule image to extract the contours and edges of objects in the capsule image. An exemplary edge extraction corresponding to the image of FIG. 4A is shown in FIG. 4B, where the contours and edges extracted are labeled as 450-460. Some objects may have multiple shading and result in multiple contours or edges. For example, the object 410 results in two contours 450a and 450b. Also, the object 414 results in two contours 454a and 454b. After edges and contours are extracted, the visual complexity can be measured based on the density of contours and edges.

There are many well known edge detection techniques in the literature. Conceptually, the existence of edge can be detected by using a gradient algorithm that measures the intensity difference of neighboring pixels in the horizontal or vertical direction. For example, a simplest form of gradient in the horizontal direction Lₓ and the vertical direction L_{y} are defined as:

$${L}_{x} = [ - 1 , + 1 ] , {L}_{y} = [ \begin{matrix}+ 1 \\ - 1\end{matrix} ] , \qquad ( 3 )$$

where the operator Lₓ corresponds the gradient ∇ₓf(x,y)=f(x+1,y)−f(x,y) and L_{y} corresponds the gradient ∇ₓf(x,y)=f(x,y+1)−f(x,y), where f(x,y) is the intensity of the image and x and y are the horizontal and vertical coordinates respectively. The gradient operators defined in (3) determine the gradient value for a location between two data points. Often it is preferred to measure the gradient at an existing location. Therefore the gradient operators L′ₓ and L′_{y} are used:

$${L}_{x}^{′} = [ - 1 , 0 , + 1 ] , {L}_{y}^{′} = [ \begin{matrix}+ 1 \\ 0 \\ - 1\end{matrix} ] , \qquad ( 4 )$$

The one-dimensional operator L′ₓ measures the gradient by calculating the intensity difference between the pixel to the right and the pixel to the left of a current pixel. Similarly, the one-dimensional operator L′_{y} measures the vertical gradient of a current location. The above operators are simple and efficient for hardware and software implementation. Nevertheless, they are more susceptible to noise. Therefore, the two-dimensional Prewitt operators P_{H} and P_{V}, as defined in (5), are often used for their reduced sensitivity to noise:

$${P}_{H} = [ \begin{matrix}+ 1 & + 1 & + 1 \\ 0 & 0 & 0 \\ - 1 & - 1 & - 1\end{matrix} ] and {P}_{V} = [ \begin{matrix}+ 1 & 0 & - 1 \\ + 1 & 0 & - 1 \\ + 1 & 0 & - 1\end{matrix} ] \qquad ( 5 )$$

While Prewitt operators average the gradients of 3 consecutive data points, there are other operators that weigh more for the data point in the center. For example, the horizontal Sobel operator S_{H} is used to detect a horizontal edge by weighing the center pixel twice as much as the neighboring pixels during the gradient calculation. Similarly the vertical Sobel operator S_{V} is used to detect a vertical edge by weighing more on the center pixel. The Sobel operators S_{H} and S_{V} are defined as:

$${S}_{H} = [ \begin{matrix}+ 1 & + 2 & + 1 \\ 0 & 0 & 0 \\ - 1 & - 2 & - 1\end{matrix} ] and {S}_{V} = [ \begin{matrix}+ 1 & 0 & - 1 \\ + 2 & 0 & - 2 \\ + 1 & 0 & - 1\end{matrix} ] \qquad ( 6 )$$

The Sobel operators shown in (6) are considered as a variation of two-dimensional gradient operation. The horizontal and vertical Sobel operators are applied to the image and the results are compared with a threshold to determine if an edge, either horizontal or vertical, exists. If an edge is detected at a pixel, the pixel is assigned a “1” to indicate the existence of an edge; otherwise a “0” is assigned to the pixel. The binary edge map indicates the object contours of the image. The visual complexity based on the edge detection can be calculated by counting the number of edge pixels, i.e. pixels being assigned a “1”. The density of edge pixels, defined as the ratio of edge pixels and the total pixels, is an indication of visual complexity.

There are many other techniques for edge detection. For example, there are convolution masks that can be used to detect horizontal, vertical, +45° and −45° edges. The operators are named C_{H}, C_{V}, C₊₄₅, and C₋₄₅, corresponding to horizontal, vertical, +45° and −45° edge detection respectively, where

$${C}_{H} = [ \begin{matrix}- 1 & - 1 & - 1 \\ + 2 & + 2 & + 2 \\ - 1 & - 1 & - 1\end{matrix} ] , {C}_{V} = [ \begin{matrix}- 1 & + 2 & - 1 \\ - 1 & + 2 & - 1 \\ - 1 & + 2 & - 1\end{matrix} ] ,$$

$${C}_{+ 45} = [ \begin{matrix}- 1 & - 1 & + 2 \\ - 1 & + 2 & - 1 \\ + 2 & - 1 & - 1\end{matrix} ] and {C}_{- 45} = [ \begin{matrix}+ 2 & - 1 & - 1 \\ - 1 & + 2 & - 1 \\ - 1 & - 1 & + 2\end{matrix} ] . \qquad ( 7 )$$

After the convolution masks are applied to the image, the results are compared with a threshold to determine if an edge exists. Accordingly, an edge map can be formed and the edge density can be calculated as a visual complexity indication. For some images, the intensity transition along the edges may not be very sharp and the images may also be subject to noise. Therefore, the detected edge may be thick and spread several pixels wide. In order to reduce the effect of edge width on the activity measurement, an image processing technique, called line thinning may be optionally applied. The edge thinning algorithm will examine the edges and remove boundary pixels to thin an edge. The technique is well known by those skilled in the field of image processing.

While the edge density is used as an example to derive visual complexity from extracted edges, other measurement may also be used. For example, further processing can be applied to extract contours based on connected edges. The number of contours may be more directly associated with the number of objects in the image. More objects in an image may require more time to recognize. While the previous example has shown counting of edge pixels as a metric for visual complexity, the number of contours or connected edge may be an alternative visual complexity measure. A contour or a connected edge can be formed from the edge pixel map and pixel connectivity. A contour is a connected edge that has no terminal edge pixel, where a terminal edge pixel is an edge pixel that only has a single edge pixel connected according to the selected connectivity. For example, the 8-connectivity can be used to form an edge connection list by starting with an initial edge pixel. For the convenience, the term “contour” may be used interchangeably with the term “connected edge”. The algorithm examines all 8 pixels around the underlying edge pixel. Any edge pixel around the underlying edge pixel is added to the connected edge list and the test is extended to newly added edge pixels. The process will iterate until no more edge pixels can be added and one contour/connected edge is declared. The process will start with another edge pixel, not already included in a contour/connected edge list. At the end of the process, every edge pixel is assigned to a connected edge list and there will be n contours/connected edges.

The contour based visual complexity can be simply the number of contours detected. However, a larger object having a larger contour may require more time to examine than a smaller object having a smaller contour. Therefore, the length of the contour should be taken into account for complexity measurement. Consequently, a metric for the contour-based visual complexity can be the summation of the length of all detected contours.

Based upon the measurement of visual complexity, each image can be assigned a temporal factor based on its visual complexity. The temporal factor is a weighting factor that causes the display time of the associated image to be varied from a nominal display time. A larger temporal factor will be assigned to an image with higher visual complexity which will cause a longer display time. For example, a temporal factor of 2 will cause the underlying images displayed twice as long, i.e., it will make the display of associated image appear to slow down so that a diagnostician may spent more time to look for anomalies. Conversely, a temporal factor of 0.5 will cause the display time shortened by half, i.e., it will make the display of underlying images appear to speed up. A temporal factor less than 1 implies the display time for the image is reduced according to the temporal factor. A temporal factor of 0.5 implies the image display time is reduced to 50% of its original display time. Nevertheless, most display devices display images at a fixed frame rate, i.e., the display time for each image is fixed. The reduced display time can be accomplished by skipping images occasionally. For example, if a series of images having a same temporal factor of 0.5, every other image can be skipped so that two images are displayed in one display period in average. This results in a temporal factor of 0.5 effectively. If a series of images having a temporal factor of 0.3, 7 images will be skipped for every 10 images in average to achieve a temporal factor of 0.3. Image skipping should be done as even as possible to reduce jerkiness for viewing. Consequently, the 4^{th}, 7^{th} and 10^{th} images of every 10 images are displayed and others are skipped. Other skipping patterns may also be used as long as 7 images are skipped every 10 images and the skipping is as uniform as possible. An exemplary image skipping and repeating can be described as follows. Let Tᵢ be the temporal factor for image i. The image i should be skipped or repeated according to the cumulated temporal factor, CTᵢ for image i, where

$${CT}_{i} = {\sum }_{k = 1}^{i} {T}_{k} . \qquad ( 8 )$$

For every image, the cumulated temporal factor, CTᵢ is checked. If the increase from CTᵢ₋₁ to CTᵢ covers an integer number, the image is displayed once. If the increase covers more than one integer, the image is repeated accordingly. Otherwise, the image is skipped. For example, in the case of 10 images having a temporal factor of 0.3, the corresponding cumulated temporal factors are {0.3, 0.6, 0.9, 1.2, 1.5, 1.8, 2.1, 2.4, 2.7, 3.0}. According to the cumulated temporal factors, the 4^{th} 7^{th} and 10^{th} images are displayed once and all others are skipped. For example, in the case of 10 images having a temporal factor of 3, the corresponding cumulated temporal factors are {3, 6, 9, 12, 15, 18, 21, 24, 27, 30}. According to the cumulated temporal factors, every image is repeated 3 times. The equation (8) is also applicable to cases that images have different temporal factors. The temporal factor should be selected to vary around 1. Furthermore, the temporal factor should be within a reasonable range so that an image will not be displayed for too long or too short. In some cases, an image sequence may contain many images having high visual complexity. Such sequence with many high complexity images will cause the total display time extended too long. It may be desirable to use a normalized temporal factor so that the total display time will remain the same when it is played at a nominal speed (for example, 30 frames per second). For a sequence having N images, the temporal factor can be normalized by multiplying the temporal factor by a normalization factor, (N/CT_{N}) where

$${CT}_{N} = {\sum }_{k = 1}^{N} {T}_{k} . \qquad ( 9 )$$

The normalized temporal factor T′ᵢ becomes Tᵢ*(N/CT_{N}) and the cumulative temporal factor for the sequence is:

$${CT}_{N}^{′} = {\sum }_{k = 1}^{N} {T}_{k}^{′} = {\sum }_{k = 1}^{N} {T}_{k}^{′} ( N / {CT}_{N} ) = N . \qquad ( 10 )$$

In other words, when the sequence is played back with the display time modified according to the normalized temporal factor, it will consume a period corresponding to N normal frames. Therefore, the total display time using the normalized temporal factor will be the same as that of the original display time. In the case of complexity too low in a sequence of images in a video, this normalization also helps to prevent excessive image skips.

FIG. 5 shows a system block diagram of one embodiment incorporating the present invention. The input interface 510 allows the system to receive images to be processed. The images may be retrieved from an output port of a capsule camera with on-board archive memory, received from a base station, or read back from a computer storage device where the images are stored. The image characteristics module 520 performs image characteristics evaluation and generates image characteristics data. The output processing module 530 receives images from input interface module 510 and extracted image characteristics from image characteristics module 520. Depending on the specific application, the output processing module will process the images and the extracted image characteristics accordingly. In a simplest case, the output processing module may just pass the received image data and the image characteristics data to its output port for further processing by other modules or systems.

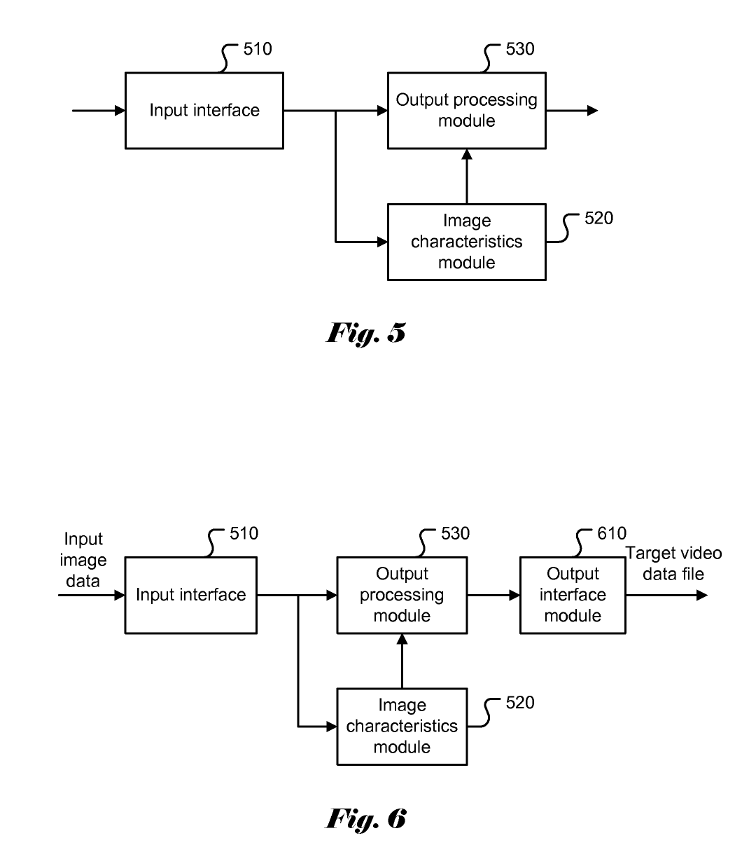

In one embodiment, the present invention is applied to images received and generates a target video file wherein the display speed of the received images has been adapted to the visual complexity and the target video can be readily displayed on any conventional display devices at normal speed. A system block diagram for such application is shown in FIG. 6. The system is substantially the same as that in FIG. 5 except for the inclusion of an output interface module 610. The components which are common to FIG. 5 and FIG. 6 are assigned the same reference numerals. The output processing module 530 will generate the temporal factors for images based on the extracted image characteristics. A global temporal factor may be provided to the output processing module 530 so that the target video will have the desired total display time according to the global temporal factor. If a global temporal factor 2 is used, this implies that the overall video will be view at half of the normal speed. In the case that a global temporal factor is not provided, a default value of 1 may be assumed. The output interface module 610 will generate the target video from the received images using the global temporal factor and individual temporal factors as control parameters. A received input image may be skipped or repeated in the target video according to the control parameters. One example of producing output video is using the cumulative temporal factor as discussed above. The generated target video is ready for viewing on any standard display device without any need for display speed control because the display speed has been properly adjusted already according to one aspect of the present invention. Other than the image skipping and repeating mentioned above, more sophisticated techniques such as frame interpolation or motion-compensated frame interpolation may be used at the expense of higher computational complexity.

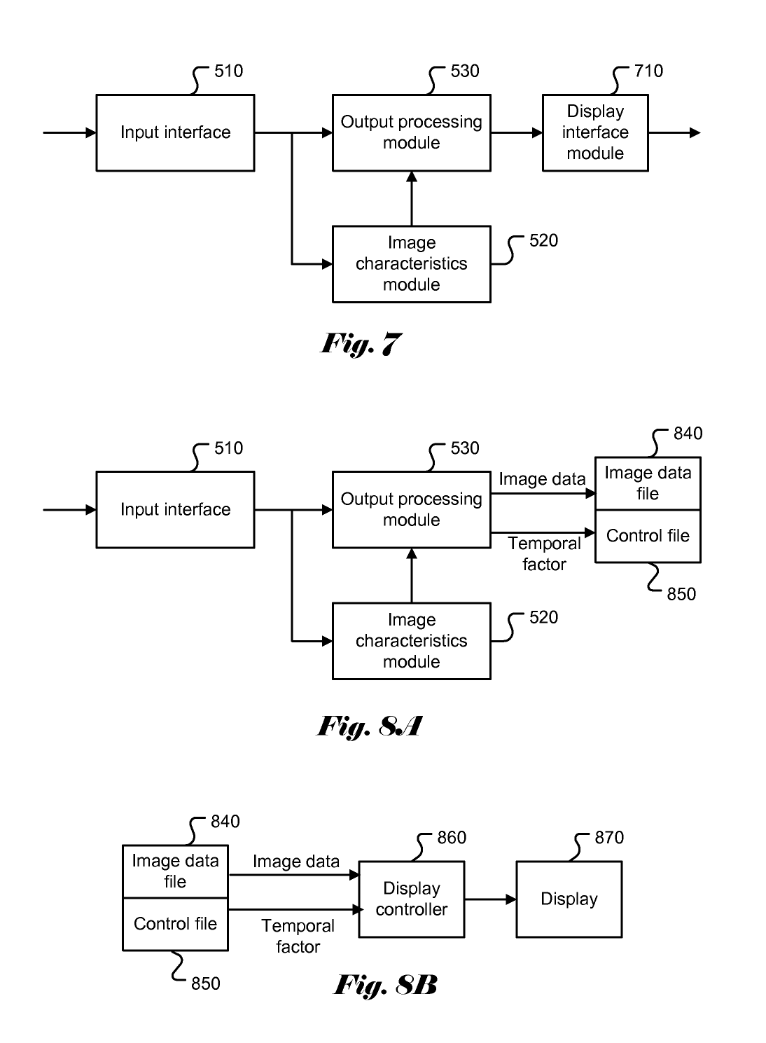

FIG. 7 shows one embodiment of the present invention for display control where the image sequence display speed is adapted to the complexity of the image. The system is substantially the same as that in FIG. 5 except for the inclusion of a display interface module 710. The components which are common to FIG. 5 and FIG. 7 are assigned the same reference numerals. The output processing module 530 will generate the temporal factors for images based on the extracted image characteristics. A global temporal factor can be provided to the output processing module 530 so that the target video will have the desired total display time according to the global temporal factor. In the case that a global temporal factor is not provided, a default value of 1 may be assumed. The display interface module 710 will generate the video frames for display from the received images using the global temporal factor and individual temporal factors as control parameters. A received image may be skipped or repeated for display according to the control parameters. On the other hand, the video frame to be displayed has to be available at the moment it is needed and video frame buffer may be needed. Methods for adjusting display speed by image skipping/repeating or frame interpolation discussed previously are applicable for the display control application as well.

FIGS. 8A-B show another embodiment of the present invention where the received image sequence file 840 and an associated control file 850 based on the temporal factors are generated. The received image file sequence 840 may already exist in some applications and it does not need to be duplicated in such applications. The control file 850 is relatively small compared with the image file 840. The control file 850 can be used by a video controller 860 to adjust the display speed of the associated image file 840. The function of the video controller 860 is similar to the video interface module 710 in FIG. 7. The video control 860 will produce video frames for display on the display device 870 under the control according to the control file 850.

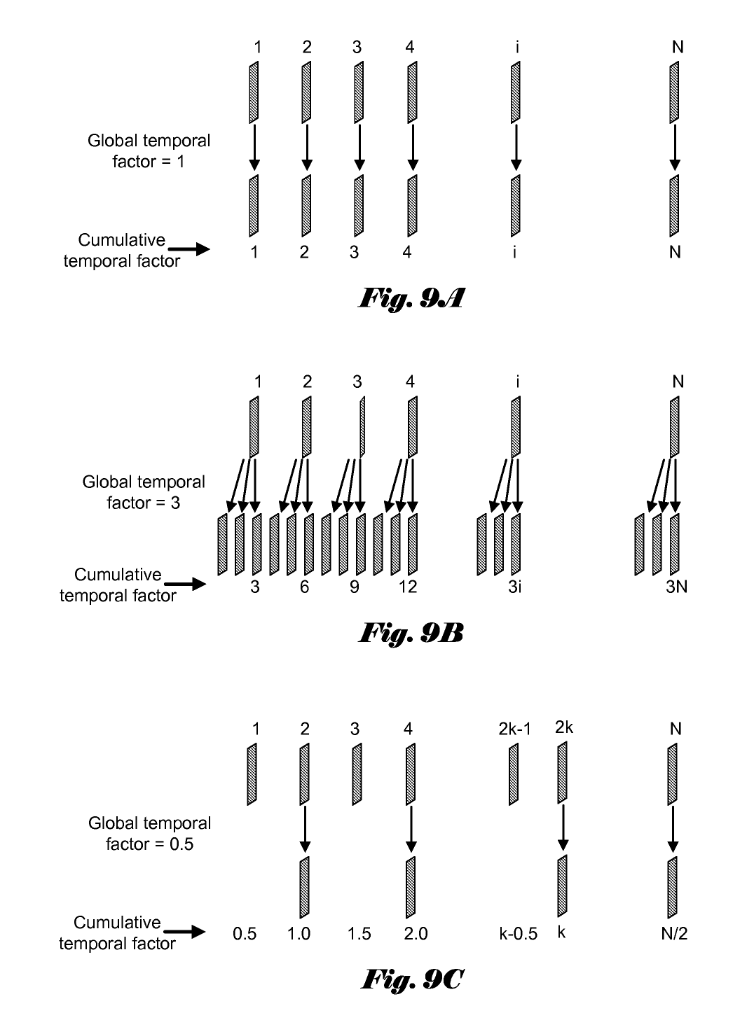

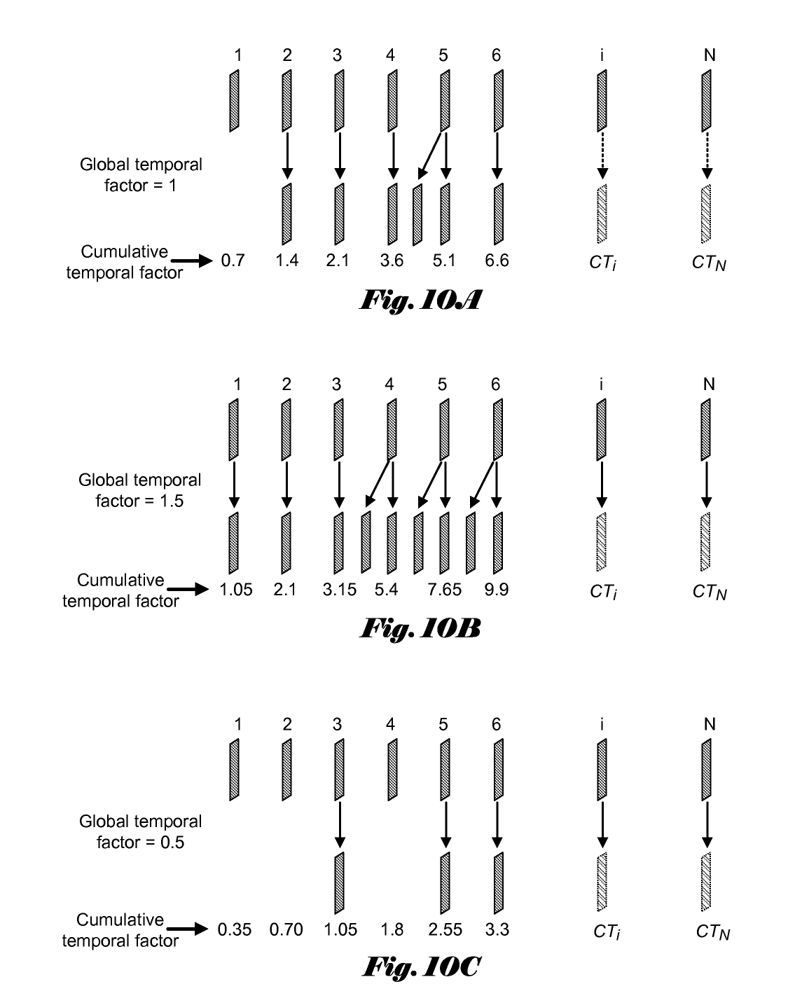

FIGS. 9A-C illustrate the effect of global temporal factor on display control where no individual temporal factor is used, i.e., temporal factor=1 for all images. FIG. 9A illustrates the case for a regular display where global temporal factor=1 and no image skipping and repeating are needed. FIG. 9B illustrates the case where global temporal factor=3. The cumulative temporal factors {3, 6, 9, . . . } are shown for respective received images. As shown in FIG. 9B, each received image is repeated 3 times based on the method discussed previously. FIG. 9C illustrates the case where global temporal factor=0.5. The cumulative temporal factors {0.5, 1.0, 1.5, 2.0, . . . } are shown for respective received images. As shown in FIG. 9C, every other received image is skipped based on the method discussed previously.

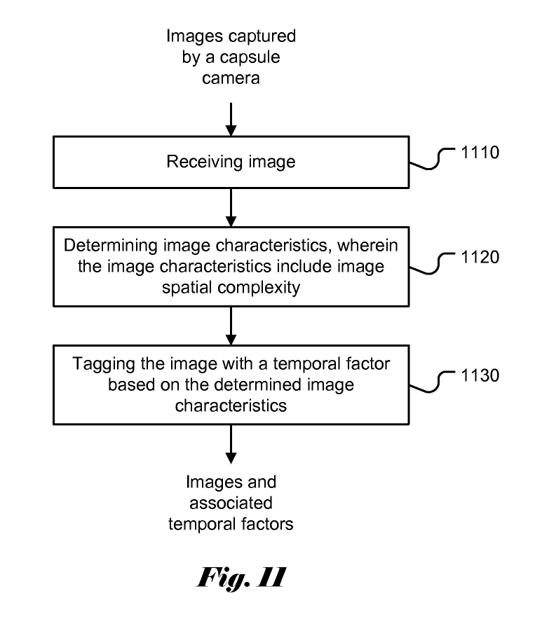

FIGS. 10A-C illustrate examples of the effect of global temporal factor on display control where the individual temporal factor based on the present invention is used. The temporal factors for the images are {0.7, 0.7, 0.7, 1.5, 1.5, 1.5, . . . }. FIG. 10A illustrates the case where global temporal factor=1. The cumulative temporal factors {0.7, 1.4, 2.1, 3.6, 5.1, 6.6, . . . } are shown for respective received images. According to the method discussed previously, the image 1 is skipped and image 5 is repeated twice. FIG. 10B illustrates the case where global temporal factor=1.5. The cumulative temporal factors {1.05, 2.1, 3.15, 5.4, 7.65, 9.9, . . . } are shown for respective received images. As shown in FIG. 10B, received images 4, 5, and 6 are repeated twice each based on the method discussed previously. FIG. 10C illustrates the case where global temporal factor=0.5. The cumulative temporal factors {0.35, 0.7, 1.05, 1.8, 2.55, 3.3, . . . } are shown for respective received images. As shown in FIG. 10C, received images 1, 2, and 4 are skipped based on the method discussed previously.

FIG. 11 shows a flowchart for processing steps of a system embodying the present invention. The images captured by a capsule camera are received at step 1110. The image characteristics are determined at step 1120, wherein the image characteristics include image spatial complexity. At step 1130, a temporal factor based on the determined image characteristics is calculated for each image and the temporal factor is tagged with the associated image.

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for processing images from a capsule camera, the method comprising:
receiving images, wherein the images are captured by a capsule camera;
determining image characteristics, wherein the image characteristics include image spatial complexity; and
tagging the image with a temporal factor based on the determined image characteristics.

2. The method of claim 1, wherein the received images are stored with the associated temporal factors.

3. The method of claim 1, wherein the received images are stored as a target video data based on the associated temporal factors and a global temporal speed, wherein each of the received images is omitted in the target video data, or outputted to the target video data once or a plurality of times according to the temporal factor associated with the image and the global temporal speed.

4. The method of claim 1, wherein the received images are displayed on a display based on the associated temporal factors and a global temporal speed, wherein each of the received images is skipped, or displayed on the display once or a plurality of times according to the temporal factor associated with the image and the global temporal speed.

5. The method of claim 1, wherein the received images are in a compressed format using a DCT-based compression method and the image spatial complexity is determined based on partial DCT coefficients.

6. The method of claim 1, wherein the received images are in a compressed format using a DCT-based compression method and the image spatial complexity is determined based on compressed image file size.

7. The method of claim 1, wherein the image spatial complexity is determined based on summation of blocks variances of the image.

8. The method of claim 1, wherein the image spatial complexity is determined based on edge feature.

9. The method of claim 8, wherein the edge feature is determined based on processing selected from the group consisting of Sobel operator and convolution masks.

10. The method of claim 1, wherein the image characteristics further include temporal complexity.

11. The method of claim 10, wherein the received images are stored with the associated temporal factors.

12. The method of claim 10, wherein the received images are stored as a target video data based on the associated temporal factors and a global temporal speed, wherein each of the received images is omitted in the target video data, or outputted to the target video data once or a plurality of times according to the temporal factor associated with the image and the global temporal speed.

13. The method of claim 10, wherein the image temporal complexity is determined based on motion evaluation between the image and a prior image

14. The method of claim 10, wherein the image spatial complexity is determined based on a simplified gradient method, wherein the gradient method calculates one-dimensional gradient values or two-dimensional gradient values.

15. A system for processing images from a capsule camera, the system comprising:
an input interface module coupled to receive images from a capsule camera system;
a processing module configured to determine image characteristics of the received image, wherein the image characteristics include image spatial complexity; and
an output processing module configured to generate outputs comprising the received image and a temporal factor based on the determined image characteristics.

16. The system of claim 15, wherein the output processing module further provides the received images and the associated temporal factors for storage.

17. The system of claim 15, further comprising an output interface module coupled to the output processing module, wherein the output interface module controls the received images being outputted to a target video data based on the associated temporal factors and a global temporal speed, wherein each of the received images is omitted in the target video data, or outputted to the target video data once or a plurality of times according to the temporal factor associated with the image and the global temporal speed.

18. The system of claim 15, further comprising a display interface module coupled to the output processing module, wherein the display interface module controls the received images being displayed on a display based on the associated temporal factors and a global temporal speed, wherein each of the received images is skipped, or displayed on the display once or a plurality of times according to the temporal factor associated with the image and the global temporal speed.

19. The system of claim 15, wherein the image characteristics further include temporal complexity.

20. The system of claim 19, wherein the output processing module further provides the received images and the associated temporal factors for storage.

21. The system of claim 19, further comprising an output interface module coupled to the output processing module, wherein the output interface module controls the received images being outputted to a target video data based on the associated temporal factors and a global temporal speed, wherein each of the received images is omitted in the target video data, or outputted to the target video data once or a plurality of times according to the temporal factor associated with the image and the global temporal speed.

22. The system of claim 19, further comprising a display interface module coupled to the output processing module, wherein the display interface module controls the received images being displayed on a display based on the associated temporal factors and a global temporal speed, wherein each of the received images is skipped, or displayed on the display once or a plurality of times according to the temporal factor associated with the image and the global temporal speed.

23. The method of claim 19, wherein the image temporal complexity is determined based on motion evaluation between the image and a prior image.
